(19) United States
(12) Patent Application Publication
(10) Pub. No.: US 2024/0165996 A1
(43) Pub. Date: May 23, 2024

(54) Tire Formulations Containing Products Derived from Depolymerized Polymers

(71) Applicant: GreenMantra Recycling Technologies Ltd., Brantford (CA)

(72) Inventors: John Almey, Burlington (CA); Benjamin Scott, Port Dover (CA)

(21) Appl. No.: 18/515,457

(22) Filed: Nov. 21, 2023

Related U.S. Application Data
(60) Provisional application No. 63/427,090, filed on Nov. 21, 2022.

(51) Int. Cl. B60C 1/00; C08J 11/10; C08K 3/04; C08K 3/06; C08K 3/22; C08K 3/36; C08K 5/09; C08K 5/18; C08K 5/47; C08L 7/00; C08L 9/06; C08L 23/12

(52) U.S. Cl. CPC B60C 1/00; C08J 11/10; C08K 3/04; C08K 3/06; C08K 3/22; C08K 3/36; C08K 5/09; C08K 5/18; C08K 5/47; C08L 7/00; C08L 9/06; C08L 23/12; C08J 2323/12; C08K 2003/2296; C08L 2205/025; C08L 2205/035; C08L 2207/20

(57) ABSTRACT

Tire formulations containing at least one depolymerized wax, a natural rubber, styrene butadiene rubber, zinc oxide, an anti-ageing agent, sulfur, a napthenic process oil, polybutadiene rubber, carbon black, a paraffin wax, a microcrystalline wax, a Fischer Tropsch wax, stearic acid, and/or a rubber accelerator are disclosed. The wax can be made by catalytic depolymerization and/or thermal degradation of polymeric material. The polymeric material can be polypropylene and/or polyethylene. In some embodiments, the polymeric material can contain at least partially recycled material.

### CROSS-REFERENCE TO RELATED APPLICATION(S)

This application is related to and claims priority benefits from U.S. Provisional Patent Application No. 63/427,090 filed on Nov. 21, 2022, entitled “Tire Formulations Containing Products Derived from Depolymerized Polymers”. The '090 application is hereby incorporated by reference herein in its entirety.

### FIELD OF THE INVENTION

The present invention relates to methods of employing polymers, oligomers, and waxes, from now on just referred to as waxes, as additives in tire formulations. The waxes can be created from the depolymerization of plastics, including recycled plastics including but not limited to polyethylene and polypropylene.

Paraffin waxes, Fischer Tropsch waxes, and/or microcrystalline waxes can be used in tire formulations to aid in reducing the damage of ozone In some embodiments, the waxes are added to tire formulations containing a natural rubber, styrene butadiene rubber, zinc oxide, an anti-ageing agent, sulfur, silica filler, polybutadiene rubber, carbon black, a napthenic process oil, stearic acid, and/or a rubber accelerator. However, these traditional waxes are petroleum derived and their creation is both environmentally damaging and energy intensive.

Depolymerized waxes can be generated from plastic feedstocks including solid waste. A process to form synthetic waxes from solid waste is discussed in U.S. Pat. No. 8,664,458 “Kumar”. U.S. Pat. No. 8,664,458 is hereby incorporated by reference.

Methods of employing waxes produced from thermal degradation and/or catalytic depolymerization of plastic feedstocks to improve the physical properties of tire formulations would be beneficial. Use of waste polymers would be commercially advantageous, environmentally responsible and offer a public health benefit.

### SUMMARY OF THE INVENTION

A tire formulation can include an amount of a depolymerized wax; an amount of a styrene butadiene rubber; an amount of a silica filler; an amount of a polybutadiene; an amount of carbon black; an amount of a paraffin wax; amount of an antioxidant; an amount of sulfur; an amount of stearic acid; and/or an amount of a rubber accelerator.

In some embodiments, the depolymerized wax is a polypropylene-based wax.

In some embodiments, the depolymerized wax is a polyethylene-based wax.

Methods of producing tire formulations containing an amount of a depolymerized wax are also disclosed.

### DETAILED DESCRIPTION OF ILLUSTRATIVE EMBODIMENT(S)

Various waxes generated from plastic feedstocks can be used to modify tire formulations containing various elements, including but not limited to at least one depolymerized wax, a natural rubber, styrene butadiene rubber, a napthenic oil, zinc oxide, an anti-ageing agent, sulfur, silica filler, polybutadiene rubber, carbon black, a paraffin wax, a microcrystalline wax, a Fischer Tropsch wax, an antioxidant, stearic acid, and/or a rubber accelerator. In some embodiments, the wax is made by catalytic depolymerization of polymeric material. In some embodiments, the wax is made by depolymerizing and/or thermally degrading polymeric material. In some embodiments, the catalyst used is a zeolite or alumina supported system or a combination of the two. In some embodiments, the catalyst is [Fe—Cu—Mo—P]/Al₂O₃.

In some embodiments, the catalyst is prepared by binding a ferrous-copper complex to an alumina or zeolite support and reacting it with an acid comprising metals and non-metals to obtain the catalyst material. In some embodiments, the catalyst comprises Al, Fe, Cu, and O, prepared by binding ferrous and copper complexes to an alumina and/or zeolite support. Other suitable catalyst materials include, but are not limited to, zeolite, mesoporous silica, H-mordenite and alumina.

In some embodiments, the wax is made by catalytically depolymerizing and/or thermally degrading polymeric material. In some embodiments, depolymerization can occur through the action of free radical initiators or the exposure to radiation.

In some embodiments, the polymeric material is polyethylene. In some embodiments, the polymeric material is polypropylene. In some embodiments, the polymeric material is polystyrene. The polymeric material can be polypropylene (PP), polystyrene (PS), high-density polyethylene (HDPE), low-density polyethylene (LDPE), linear low-density polyethylene (LLDPE), and/or other variations of polyethylene.

In other embodiments, the polymeric material includes both polyethylene and polypropylene material. In some embodiments, the polymeric material is divided evenly by weight between polyethylene and polypropylene. In some embodiments, the polymeric material can contain between 0% to 20% by weight PP, lower levels of polystyrene, polyethylene terephthalate (PET), ethylene-vinyl acetate (EVA), polyvinyl chloride (PVC), ethylene vinyl alcohol (EVOH), and undesirable additives and/or contaminants, such as fillers, dyes, metals, various organic and inorganic additives, moisture, food waste, dirt, and/or other contaminating particles.

In some embodiments, the resulting wax includes greater than 20 ppm of iron; greater than 50 ppm of zinc; and/or greater than 20 ppm of titanium as determined by x-ray fluorescence. The presence of these metals can confirm that the waxes were derived through either post-consumer or post-industrial waste polymers. In at least some embodiments, these metals also well dispersed in the resulting waxes adding both polarity and reactivity. This can make the resulting waxes more compatible in various organic and aqueous solvent formations than traditional waxes. In addition, the added metal content can allow the resulting waxes to act as a coupling agent with other multi-polymer systems.

In other embodiments, the polymeric material includes combinations of LDPE, LLDPE, HDPE, and PP.

In some embodiments, the polymeric material comprises recycled plastics including, but not limited to, polyolefin, polystyrene, polyethylene, terephthalate, and/or multi-layer plastics. In other or the same embodiments, the polymeric material comprises recycled plastics and/or virgin plastics.

In some embodiments, the polymeric material includes waste polymeric material feed. Suitable waste polymeric material feeds include mixed polystyrene waste, mixed polyethylene waste, mixed polypropylene waste, and/or a mixture including mixed polyethylene waste and mixed polypropylene waste. In some embodiments, the mixed polyethylene waste can include LDPE, LLDPE, HDPE, PP, or a mixture including combinations of LDPE, LLDPE, HDPE, and/or PP. In some embodiments, the mixed polyethylene waste can include film bags, milk jugs or pouches, totes, pails, caps, agricultural film, and/or packaging material. In some embodiments, the mixed polypropylene waste can include carpet fibers, bottle caps, yogurt containers, and/or bottle labels. In some embodiments, the mixed polystyrene waste can include food packaging containers, insulation, and/or electronic packaging. In some embodiments, the waste polymeric material feed includes up to 10% by weight of material other than polymeric material, based on the total weight of the waste polymeric material feed. In some embodiments, the waste polymeric material feed includes 1% to 10% by weight of material other than polymeric material, based on the total weight of the waste polymeric material feed.

In some embodiments, the polymeric material is one of, or a combination of, virgin polyethylene (any one of, or combinations of, HDPE, LDPE, LLDPE and medium-density polyethylene (MDPE)), virgin polypropylene, or post-consumer, or post-industrial, polyethylene and/or polypropylene (exemplary sources including bags, jugs, bottles, pails, and/or other items containing PE and/or PP).

In some embodiments, the addition of the depolymerized wax changes the physical characteristics of the tire formulations including, but not limited to:
improving the lifespan of a tire by reducing the damage potential of ozone, which leads to cracking;
reducing the number of additional waxes needed to be used in the formulation, for instance if both a microcrystalline and a paraffin wax are needed in a formulation, in some embodiments it is possible to substitute both with one polyethylene wax.
reducing, or even eliminating, tire “blooming”, as many of the depolymerized waxes made from recycled materials are naturally darker in color;
increasing the melt flow rate during manufacturing; and/or
improving the mold release during manufacturing.

In some embodiments, the tire formulation can include at least one depolymerized wax, a natural rubber, styrene butadiene rubber, zinc oxide, an anti-ageing agent, sulfur, silica filler, polybutadiene rubber, carbon black, a paraffin wax, a microcrystalline wax, a Fischer Tropsch wax, stearic acid, a napthenic process oil, and/or a rubber accelerator.

In some embodiments, the natural rubber can be, but is not limited to, a constant viscosity (CV) rubber such as CV60.

In some embodiments, the anti-ageing agent can be, but is not limited to, a paraphenylenediamine (PPD).

In some embodiments, the rubber accelerator can be, but is not limited to, N-tert-butyl-2 benzothiazolesulfenamide (BBTS).

In some embodiments, the napthenic process oil can be, but is not limited to, Calsol™ M 8240.

In some embodiments, the percentage of depolymerized wax in the tire formulation can be between and inclusive of 0.5 to 10 percent by weight. In some preferred embodiments, the percentage of depolymerized wax in the tire formulation can be between and inclusive of 1-5 percent by weight.

In some embodiments, the percentage of the natural rubber in the tire formulation can be between and inclusive of 10-80 percent by weight. In some preferred embodiments, the percentage of the natural rubber in the tire formulation can be between and inclusive of 40-60 percent by weight.

In some embodiments, the percentage of zinc oxide in the tire formulation can be between and inclusive of 1-5 percent by weight. In some preferred embodiments, the percentage of zinc oxide in the tire formulation can be between and inclusive of 2-4 percent by weight.

In some embodiments, the percentage of the anti-ageing agent in the tire formulation can be between and inclusive of 0.5-10 percent by weight. In some preferred embodiments, the percentage of the anti-ageing agent in the tire formulation can be between and inclusive of 1-3 percent by weight.

In some embodiments, the percentage of the sulfur in the tire formulation can be between and inclusive of 0.5 to 5 percent by weight. In some preferred embodiments, the percentage of the sulfur in the tire formulation can be between and inclusive of 1-3 percent by weight.

In some embodiments, the percentage of styrene butadiene rubber in the tire formulation can be between and inclusive of 10-70 percent by weight. In some preferred embodiments, the percentage of styrene butadiene rubber in the tire formulation can be between and inclusive of 15-30 percent by weight.

In some embodiments, the percentage of silica filler in the tire formulation can be between and inclusive of 20-50 percent by weight. In some preferred embodiments, the percentage of silica filler in the tire formulation can be between and inclusive of 25-30 percent by weight.

In some embodiments, the percentage of polybutadiene rubber in the tire formulation can be between and inclusive of 15-70 percent by weight. In some preferred embodiments, the percentage of polybutadiene in the tire formulation can be between and inclusive of 40-50 percent by weight.

In some embodiments, the percentage of carbon black in the tire formulation can be between and inclusive of 10-60 percent by weight. In some preferred embodiments, the percentage of carbon black in the tire formulation can be between and inclusive of 45-55 percent by weight.

In some embodiments, the percentage of the stearic acid can be between and inclusive of 0.5 to 5 percent by weight. In some preferred embodiments, the percentage of the stearic acid in the tire formulation can be between and inclusive of 1-2 percent by weight.

In some embodiments, the percentage of the rubber accelerator in the tire formulation can be between and inclusive of 0.5 to 5 percent by weight. In some preferred embodiments, the percentage of the rubber accelerator in the tire formulation can be between and inclusive of 1-2 percent by weight.

In some embodiments, the percentage of the paraffin wax in the tire formulation can be between and inclusive of 1-10 percent by weight. In some preferred embodiments, the percentage of the paraffin wax in the tire formulation can be between and inclusive of 2-5 percent by weight.

In some embodiments, the percentage of the microcrystalline wax in the tire formulation can be between and inclusive of 1-10 percent by weight. In some preferred embodiments, the percentage of the microcrystalline wax in the tire formulation can be between and inclusive of 2-5 percent by weight.

In some embodiments, the percentage of the Fischer Tropsch wax in the tire formulation can be between and inclusive of 1-10 percent by weight. In some preferred embodiments, the percentage of the Fischer Tropsch wax in the tire formulation can be between and inclusive of 2-5 percent by weight.

In some embodiments, the depolymerized wax is a polypropylene-based wax. In some embodiments, the depolymerized wax is a polyethylene-based wax.

In some embodiments the waxes can have melting points between and inclusive of 100-170° C., viscosities between and inclusive of 20-10,000 cps, and/or acid numbers between and inclusive of 0-50 mg KOH/g. In some preferred embodiments, the wax(es) employed have melting points between and inclusive of 110-170° C., viscosities between and inclusive of 20-5,000 cps, and/or acid numbers between and inclusive of 0-34 mg KOH/g. In some more preferred embodiments, the wax(es) employed have melting points between and inclusive of 112-166° C., viscosities between and inclusive of 37.5-3000 cps, and/or acid numbers between and inclusive of 0-22 mg KOH/g. In some even more preferred embodiments, the waxes have viscosities between 100-350 cps. In some embodiments, the waxes have dropping points between 113-119° C.

Changes in melting point, viscosity, molecular weight, and/or polymer backbone structure of the wax can change the properties of the tire formulation. In general, addition of waxes will reduce the damage from ozone and can potentially reduce the damage from heating, and aid in processing.

In some embodiments, use of waxes can produce a stable tire formulation.

In some embodiments, the natural rubber, styrene butadiene rubber, zinc oxide, anti-ageing agent, sulfur, silica filler, polybutadiene rubber, carbon black, stearic acid, and/or rubber accelerator and wax(es) are mixed together.

In some embodiments, a banbury or similar mixer is used. In some embodiments, the mixing is conducted at temperatures between and inclusive of 120 C to 160° ° C.

Changes to the wax, including but not limited to its molecular weight, and/or polymer backbone structure, can change the properties of the final tire formulation.

In some embodiments the depolymerized wax offsets, if not eliminates, the use of paraffin waxes, Fischer Tropsch waxes, and/or microcrystalline waxes without negatively affecting the tire formulation.

Any numerical value ranges recited herein include all values from the lower value to the upper value in increments of one unit provided that there is a separation of at least two units between any lower value and any higher value. For example, if a range is listed from 1 to 100, specifically from 30 to 70, more specifically from 40 to 50, it is intended that values such as 25 to 75, 27 to 65, 45 to 60, 32 to 37, and so on, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A tire formulation comprising:
an amount of a depolymerized wax;
an amount of a styrene butadiene rubber;
an amount of a silica filler;
an amount of a polybutadiene; and
an amount of carbon black.

2. The tire formulation of claim 1 further comprising at least two of an amount of an antioxidant, an amount of sulfur, an amount of stearic acid, and/or an amount of a rubber accelerator.

3. The tire formulation of claim 1 further comprising an amount of a paraffin wax.

4. The tire formulation of claim 1 further comprising an amount of an antioxidant.

5. The tire formulation of claim 1 further comprising an amount of sulfur.

6. The tire formulation of claim 1 further comprising an amount of stearic acid.

7. The tire formulation of claim 1 further comprising an amount of a rubber accelerator.

8. The tire formulation of claim 1 wherein said depolymerized wax is a polypropylene-based wax.

9. The tire formulation of claim 1 wherein said depolymerized wax is a polyethylene-based wax.

10. The tire formulation of claim 1 further comprising an amount of a natural rubber.

11. The tire formulation of claim 1 further comprising an amount of zinc oxide.

12. The tire formulation of claim 1 further comprising an amount of an anti-ageing agent.

13. The tire formulation of claim 10 wherein said natural rubber is CV60.

14. The tire formulation of claim 12 wherein said anti-ageing agent is a paraphenylenediamine.

15. The tire formulation of claim 7 wherein said rubber accelerator is N-tert-butyl-2 benzothiazolesulfenamide.

16. The tire formulation of claim 1 wherein said amount of said depolymerized wax is between and inclusive of 1-5 percent by weight of said tire formulation.

17. The tire formulation of claim 10 wherein said amount of said natural rubber is between and inclusive of 40-60 percent by weight of said tire formulation.

18. The tire formulation of claim 11 wherein said amount of zinc oxide is between and inclusive of 2-4 percent by weight of said tire formulation.

19. The tire formulation of claim 14 wherein said amount of said anti-ageing agent is between and inclusive of 1-3 percent by weight of said tire formulation.

20. A tire formulation comprising:
an amount of a depolymerized wax;
an amount of a styrene butadiene rubber;
an amount of a silica filler;
an amount of a polybutadiene;
an amount of carbon black;
an amount of an antioxidant;
an amount of sulfur;
an amount of stearic acid;
an amount of a rubber accelerator, wherein said rubber accelerator is N-tert-butyl-2 benzothiazolesulfenamide;
an amount of zinc oxide; and
an amount of paraphenylenediamine;
wherein said depolymerized wax is a polypropylene-based wax,
wherein said amount of said depolymerized wax is between and inclusive of 1-5 percent by weight of said tire formulation,
wherein said amount of zinc oxide is between and inclusive of 2-4 percent by weight of said tire formulation,
wherein said amount of anti-ageing agent is between and inclusive of 1-3 percent by weight of said tire formulation,
wherein said amount of sulfur is between and inclusive of 1-3 percent by weight of said tire formulation,
wherein said amount of styrene butadiene rubber is between and inclusive of 15-30 percent by weight of said tire formulation,
wherein said amount of silica filler is between and inclusive of 25-30 percent by weight of said tire formulation.
